(19) United States
(12) Patent Application Publication
(10) Pub. No.: US 2013/0222376 A1
(43) Pub. Date: Aug. 29, 2013

(54) STEREO IMAGE DISPLAY DEVICE

(71) Applicant: Panasonic Corporation, (US)

(72) Inventors: Hiroaki SHIMAZAKI, Tokyo (JP); Tatsuro JURI, Osaka (JP); Kenjiro TSUDA, Kyoto (JP); Kazuhito KIMURA, Shiga (JP); Takashi MASUNO, Osaka (JP)

(73) Assignee: Panasonic Corporation, Osaka (JP)

(21) Appl. No.: 13/861,796

(22) Filed: Apr. 12, 2013

Related U.S. Application Data
(63) Continuation of application No. PCT/JP2011/005728, filed on Oct. 13, 2011.

(30) Foreign Application Priority Data
Oct. 14, 2010 (JP) 2010-231229

(51) Int. Cl. G09G 5/14; G06F 3/041

(52) U.S. Cl. CPC G09G 5/14; G06F 3/041
USPC 345/419; 345/173

(57) ABSTRACT

A stereo image display device includes an image input unit that obtains image data representing a stereo image, a display unit that displays an image based on the image data, an operation unit that receives pointing position on an image displayed on the display unit, an information calculator that obtains parallax information on a portion corresponding to the position pointed by the operation unit in the image data, and a controller that controls the display unit to display the parallax information obtained as well as the image. The display unit displays the parallax information in a format representing a magnitude and a direction of parallax. The operation unit receives a command for changing the magnitude of parallax represented by the parallax information. The controller changes a magnitude of parallax on the portion corresponding to the pointed position in the image data based on the changing command received by the operation unit.

### CROSS-REFERENCE TO RELATED APPLICATIONS

This is a continuation application of International Application No. PLT/JP2011/005728, with an international filing date of Oct. 13, 2011, which claims priority of Japanese Patent Application No.: 2010-231229 filed on Oct. 14, 2010, the content of which is incorporated herein by reference.

### BACKGROUND

1. Technical Field

The technical fields relates to a stereo image display device for displaying a stereo image.

2. Related Art

Conventionally, an apparatus for preparing a left-eye image and a right-eye image which have parallax as a stereo image, and projecting them on left and right eyes independently through shutter type eyeglasses to provide stereoscopic vision is present. With this apparatus, a user adjusts parallax of stereoscopic video signals while viewing a two-dimensional video obtained by synthesizing a left-eye image and a right-eye image in a multiplexed manner (for example, see Japanese Patent Application Laid-Open No. 2005-110120).

In another method, when pixels of which visual load for users is large due to large parallax increase in an image, the pixels of which visual load is large are colored to be displayed, and parallax is adjusted while these pixels are being viewed (for example, see Paper on Feasibility Study about Environmental Development of Next-Generation Stereoscopic Contents Production, The Mechanical Social Systems Foundation, March 2009, pages 41 to 43).

### SUMMARY

However, in the conventional technique, information about parallax obtained based on a left-eye image and a right-eye image can be adjusted on an entire image, but cannot be adjusted on a certain partial region.

The present disclosure provides a stereo image display device for while displaying an image based on a left-eye image and a right-eye image, being capable of adjusting parallax information on any region pointed within the image.

A stereo image display device according to the present disclosure includes an image input unit operable to obtain image data representing a stereo image, a display unit operable to display an image based on the image data obtained by the image input unit, an operation unit operable to receive pointing position on an image displayed on the display unit, an information calculator operable to obtain parallax information on a portion corresponding to the position pointed by the operation unit in the image data obtained by the image input unit, and a controller operable to control the display unit to display the parallax information obtained by the information calculator as well as the image. The display unit displays the parallax information in a format representing a magnitude and a direction of parallax. The operation unit receives a command for changing the magnitude of parallax represented by the parallax information. The controller changes a magnitude of parallax on the portion corresponding to the pointed position in the image data based on the changing command received by the operation unit.

With this configuration, the stereo image display device can point a position within the image based on image data representing a stereo image. Parallax information about a portion corresponding to the pointed position can be displayed together with an image displayed on a display unit. As a result, a user checks the image based on the image data representing the stereo image and simultaneously can check the parallax information on the pointed portion.

Further, the stereo image display device can change a magnitude of the parallax of the image data obtained by the image input unit according to a change in a size of the parallax information. As a result, the user can check the parallax information displayed on the display unit and adjust the parallax of the stereo image only through changing of the size of the parallax information.

The stereo image display device of the present disclosure can display the parallax information on the pointed position as well as at least the image based on the image data representing the stereo image. The parallax information on the pointed position can be easily adjusted. For this reason, the present disclosure can provide the stereo image display device that can be user-friendly for users.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 is a diagram illustrating a hardware configuration of a stereo camera according to an embodiment.

FIG. 2 is a diagram for describing an operation for calculating parallax information performed by a parallax information calculator.

FIG. 3 is a diagram for describing a configuration of the stereo camera and a display screen of a display unit.

FIG. 4 is a flowchart illustrating an operation for displaying a video signal output from a display processor performed by the display unit.

FIG. 5 is a diagram illustrating the stereo camera in a case where parallax information is displayed on the display unit.

FIG. 6 is a diagram illustrating an example of the stereo camera in a case where the parallax information is displayed on the display unit.

FIG. 7 is a diagram illustrating an example of the stereo camera in the case where the parallax information is displayed on the display unit.

FIG. 8 is a conceptual diagram describing an example where a level that the parallax information exceeds an allowable value in the stereo camera.

FIGS. 9A and 9B are conceptual diagrams describing an example of display using a predetermined number of marks and graph in decreasing order of parallax in the stereo camera.

FIGS. 10A and 10B are conceptual diagrams describing an example of display with a predetermined number of color coding zebra patterns in decreasing order of parallax in the stereo camera.

FIGS. 11A and 11B are conceptual diagrams describing an example where parallax information about a focus point as well as a maximum parallax value is displayed in the stereo camera.

FIGS. 12A to 12C are diagrams for describing adjustment of the parallax information though a dragging operation.

FIG. 13 is a diagram illustrating an example of the stereo camera in the case where the parallax information is displayed on the display unit.

FIGS. 14A and 14B are conceptual diagrams describing an operation for setting parallax on a touched position to 0 in the stereo camera.

FIGS. 15A and 15B are diagrams for describing a shifting process executed by the stereo camera.

FIGS. 16A to 16D are conceptual diagrams describing an operation for adjusting actual parallax information through adjustment of a shooting parameter of an imaging unit in the stereo camera.

FIGS. 17A and 17B are conceptual diagrams describing an operation for display a warning in a case where the maximum parallax value is switched due to the parallax adjustment in the stereo camera.

FIGS. 18A and 18B are conceptual diagrams describing an example where parallax is not displayed when the stereo camera is moved in the stereo camera.

FIGS. 19A and 19B are diagrams describing an example where a shading process is executed on a portion having parallax larger than parallax of the touched position in the stereo camera.

FIGS. 20A and 20B are diagram describing an example where the portion of which parallax information is displayed is enlarged to be displayed in the stereo camera.

### DETAILED DESCRIPTION

### Embodiment

An embodiment is described below with reference to the drawings.

### 1. Configuration

### 1-1. Hardware Configuration of Stereo Camera

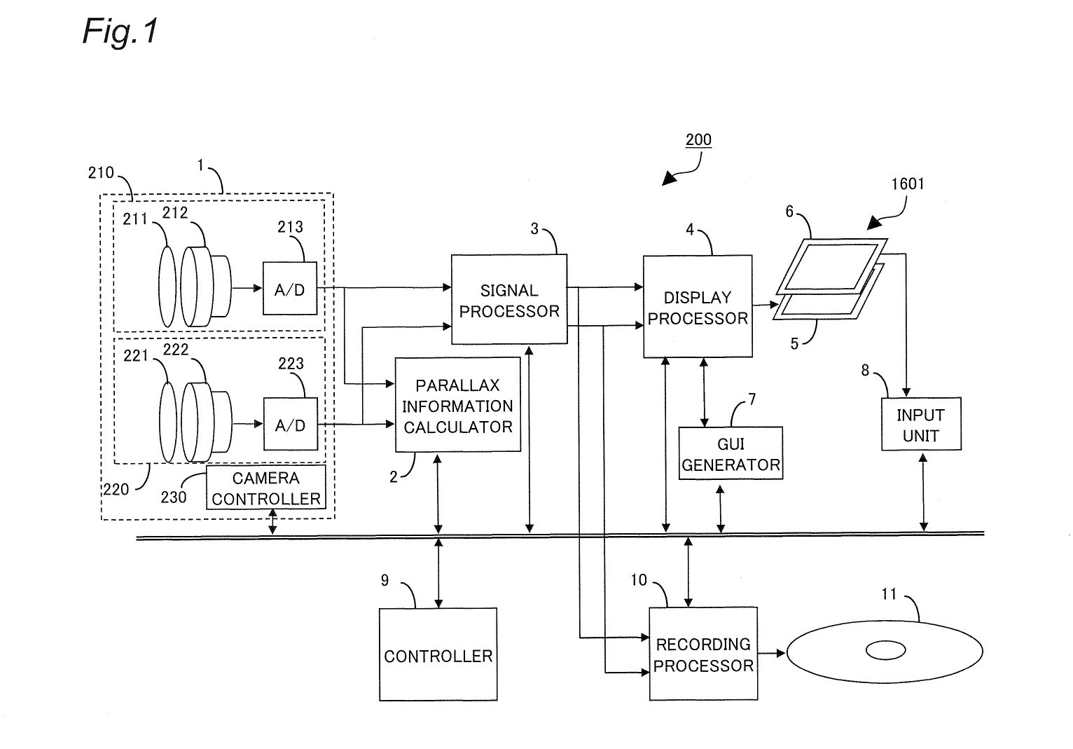

FIG. 1 is a diagram illustrating a hardware configuration of a stereo camera capable of capturing a stereo image according to the embodiment. As shown in FIG. 1, a stereo camera 200 includes an imaging unit 1, a parallax information calculator 2, a signal processor 3, a display processor 4, a display unit 5, an operation unit 6, a GUI generator 7, an input unit 8, a controller 9, a recording processor 10, and a recording medium 11. The recording medium 11 is not limited to one built in the stereo camera, and may be a portable medium detachable from the stereo camera 200.

The imaging unit 1 has a first optical system 210, a second optical system 220, and a camera controller 230. The first optical system 210 is arranged on a first viewpoint position, and has a first lens group 211, a first imager 212, and a first A/D converter 213. The second optical system 220 is arranged on a second viewpoint position, and has a second lens group 221, a second imager 222, and a second A/D converter 223.

The first lens group 211 is composed of a plurality of optical lenses. The first lens group 211 collects light incident to the first imager 212.

The first imager 212 is composed of an imaging device, and captures light incident through the first lens group 211. Concretely, the first imager 212 converts an input light signal into an analog signal (electric signal), and outputs the analog signal to the first A/D converter 213.

The first A/D converter 213 converts the analog signal output from the first imager 212 into a digital signal. The first A/D converter 213 outputs the converted digital signal as a first image to the parallax information calculator 2 and the signal processor 3.

The second lens group 221 is composed of a plurality of optical lenses. The second lens group 221 collects light incident to the second imager 222.

The second imager 222 is composed of an imaging device, and captures light indent through the second lens group 221. Concretely, the second imager 222 converts an input light signal into an analog signal (electric signal), and outputs the analog signal to the second A/D converter 223.

The second A/D converter 223 converts an analog signal output from the second imager 222 into a digital signal. The second A/D converter 223 outputs the converted digital signal as a second image to the parallax information calculator 2 and the signal processor 3.

In the above configuration, the first optical system 210 and the second optical system 220 are separate from each other. However, the first optical system 210 and the second optical system 220 may be formed into the same (single) device. In other words, the first optical system 210 and the second optical system 220 may have any configuration as long as they can obtain a first image on the first viewpoint position and a second image on the second viewpoint position.

The camera controller 230 controls the respective units of the imaging unit 1 to perform operations corresponding to shooting parameters, such as a focal distance and an aperture value under control of the controller 9.

The parallax information calculator 2 calculates information about parallax of a stereo image composed of a first image and a second image (hereinafter, parallax information) based on image data composing the input first image and second image. The parallax information calculator 2 outputs the calculated parallax information to the GUI generator 7. For example, the parallax information calculator 2 divides the first image and the second image into a plurality of regions, and calculates the parallax information for each of the divided regions. The divided regions may be of any size, for example, 16×16 pixels. The parallax information calculator 2 may use any method such as block matching method for calculating the parallax information.

The parallax information means a value indicating a shift amount (hereinafter, “a magnitude of parallax”) in a horizontal direction of a horizontal position of an object on a second image with respect to a horizontal position of the object on a first image when the object is commonly captured on both the first image and second image and a position of the object on the second image is different from a position of the object on the first image. For example, the parallax information may be a pixel value as the shift amount in the horizontal direction. As to display of the parallax information, a magnitude of parallax may be displayed in a numerical value, or may be displayed in a vector as described later. In this case, the parallax information is a concept including the magnitude (amount) of parallax and an orientation (direction) of parallax.

The first image and the second image may be images generated by the imaging unit 1 or images read from the recording medium 11. That is to say, images to be input into the parallax information calculator 2 are not limited to the first image and the second image generated by the imaging unit 1.

Concretely, the parallax information calculator 2 calculates parallax information corresponding to a position pointed by a user through the operation unit 6 based on a signal from the controller 9.

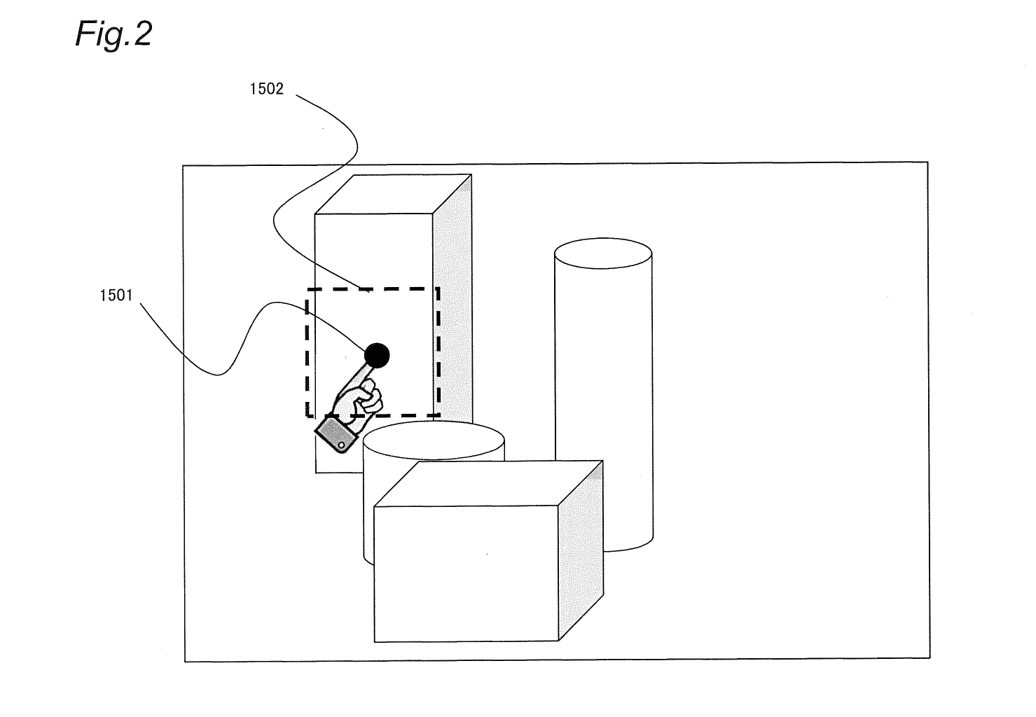

FIG. 2 is a diagram for describing an operation for calculating parallax information performed by the parallax information calculator 2.

When the user points a position 1501 through the operation unit 6, the parallax information calculator 2 calculates parallax information on a region 1502 including the position 1501. In this case, an average value of parallax information (a magnitude of parallax, a direction of parallax) is calculated from image data included in the region 1502. The parallax information calculator 2 may calculate parallax information on the position 1501 instead of parallax information on the region 1502. In short, the region 1502 may be composed of a plurality of pixels or one pixel.

Further, the parallax information calculator 2 outputs to the controller 9 maximum parallax information in the parallax information on the entire region of the image. The maximum parallax information means parallax information in which a magnitude of parallax composing the parallax information is maximum in a plurality of pieces of parallax information. Further, the maximum parallax information means at least one piece of parallax information about an object viewed as being popped out most (the closest to the user) and parallax information about an object viewed as being retreated most when the user views a first image and a second image as a stereoscopic video. In short, the parallax information about the object viewed as being popped out most may be the maximum parallax information. Further, the parallax information about the object viewed as being retreated most (farthest from the user) may be the maximum parallax information. Further, both parallax information about the object viewed as being popped out most and the parallax information about the object viewed as being retreated most may be the maximum parallax information.

The signal processor 3 executes various processes on the first image and the second image generated by the imaging unit 1. The signal processor 3 executes a process on image data composing either or both of the first image and the second image, generates a review image as the image data to be displayed on the display unit 5, and generates a video signal to be recorded. For example, the signal processor 3 executes various video processes such as gamma correction, white balance correction and flaw correction on the first image and second image. The signal processor 3 outputs the generated review image to the display processor 4. A review image generated by the signal processor 3 may be a two-dimensional image or a three-dimensional image.

The signal processor 3 executes a compressing process on the processed first image and second image according to a compressing format that meet the JPEG standards. Compressed signals obtained by compressing the first image and the second image are related to each other and are recorded in the recording medium 11 via the recording processor 10. For example, the compressed signals are recorded in an MPO file format upon recording of the respective compressed signals. When a video signal to be compressed is a moving image, a moving image compressing standard such as H.264/AVC is employed. Further, the image in the MPO file format and the JPEG image or the MPEG moving image may be simultaneously recorded. The compressing format and the file format that are applied to the recording of the first image and the second image may be any formats as long as they are suitable for stereo images.

The signal processor 3 executes the signal processes on the first image and the second image based on a signal input from the controller 9, and adjusts parallax. Concretely, the signal processes executed by the signal processor 3 are realized by, for example, a trimming process. The signal processes executed by the signal processor 3 are not limited to the above method, and may be any methods as long as parallax can be electronically adjusted.

The signal processor 3 can be realized by DSP or a microcomputer. Resolution of a review image may be set equal to image resolution of the display unit 5, or may be set equal to resolution of image data which is compressed and generated by the compressing format conforming to the JPEG standards.

The display processor 4 superimposes a GUI image input from the GUI generator 7a on a review image input from the signal processor 3. The display processor 4 outputs a video signal obtained by the superimposing to the display unit 5.

The display unit 5 displays a video signal input from the display processor 4.

The operation unit 6 includes a touch panel and receives a touching operation from the user. When receiving the touching operation from the user, the operation unit 6 converts the operation into an electric signal to output it to the input unit 8. The user can point any position in an image displayed on the display unit 5 through the touching operation of the operation unit 6. The operation unit 6 is not limited to the touch panel, and may be composed of an operation member that can input information about up, down, right and left directions. The operation unit 6 may be a joy stick that can input information about any direction. That is to say, as the operation unit 6, any device may be used as long as it receives user's operations.

The GUI generator 7 generates a GUI (Graphical User Interface) image based on a signal input from the controller 9. For example, the GUI generator 7 generates and displays a GUI image relating to parallax information on a position pointed by the user through the operation unit 6 within a video displayed on the display unit 5. The GUI generator 7 generates the GUI image including the parallax information corresponding to the position pointed by the user through the operation unit 6 within the video displayed on the display unit 5. The GUI generator 7 may generate a GUI image including parallax information in a vector format as a display element. The vector format is a display format that clarifies a parallax magnitude (an amount of parallax) and a parallax direction (an orientation) including the parallax information, and, for example, a display format expressed by an arrow. That is to say, the parallax direction is expressed by an orientation of the arrow, and the magnitude of parallax is expressed by a length of the arrow. When the parallax information is displayed in the vector format, the format is not limited to the arrow and parallax information may be displayed in another format for clarifying its direction and its magnitude.

The input unit 8 receives an electric signal from the operation unit 6, and outputs a signal based on the received electric signal to the controller 9.

When an electric signal on the same position on an image displayed on the display unit 5 is sequentially input from the operation unit 6 through a user's operation of the operation unit 6, the input unit 8 outputs a signal for instructing parallax adjustment to the controller 9.

Further, when an electric signal for specifying a dragging operation is input from the operation unit 6 through a user's operation of the operation unit 6, the input unit 8 outputs a signal for instructing the adjustment of parallax according to the dragging operation to the controller 9.

The controller 9 entirely controls the stereo camera 200.

The recording processor 10 records the first image and the second image input from the signal processor 3 into the recording medium 11.

### 1-2. Display Screen

A display screen displayed on the display unit 5 based on a video signal generated by the display processor 4 in this embodiment is described below with reference to the drawings.

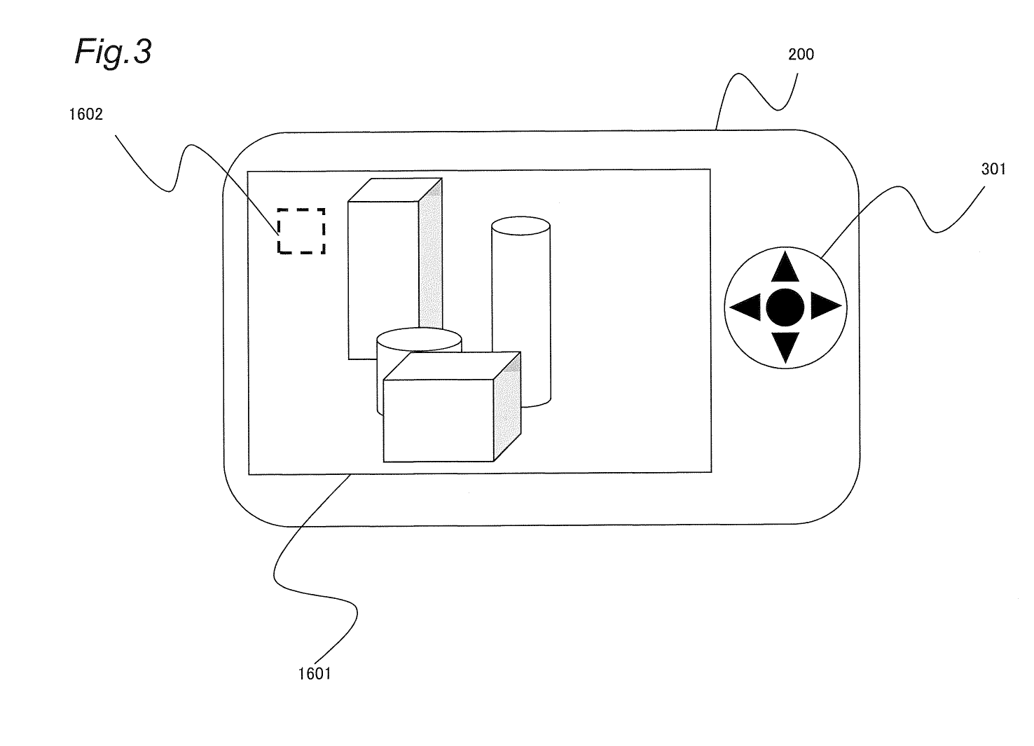

FIG. 3 is a diagram for describing a configuration of the stereo camera 200 and the display screen of the display unit 5. As shown in FIG. 3, the stereo camera 200 has an operation member 301 that receives user's operations. The operation member 301 may be configured by the operation unit 6.

The user can instruct operations in the up-down, right and left directions and determination via the operation member 301.

The display unit 5 and the operation unit 6 are configured integrally as a display screen 1601.

The user can perform a touching operation or a dragging operation via the display screen 1601. When receiving the touching operation from the user, the stereo camera 200 displays a region 1602 including a position touched on the display screen 1601 that is indicated by a frame of broken line. The user can move the region 1602 via the operation member 301. For example, when the user instructs the operation in the up direction via the operation member 301, the region 1602 moves to the up direction. Further, the user can point a position of the region 1602 via the operation member 301.

### 1-3. Operation

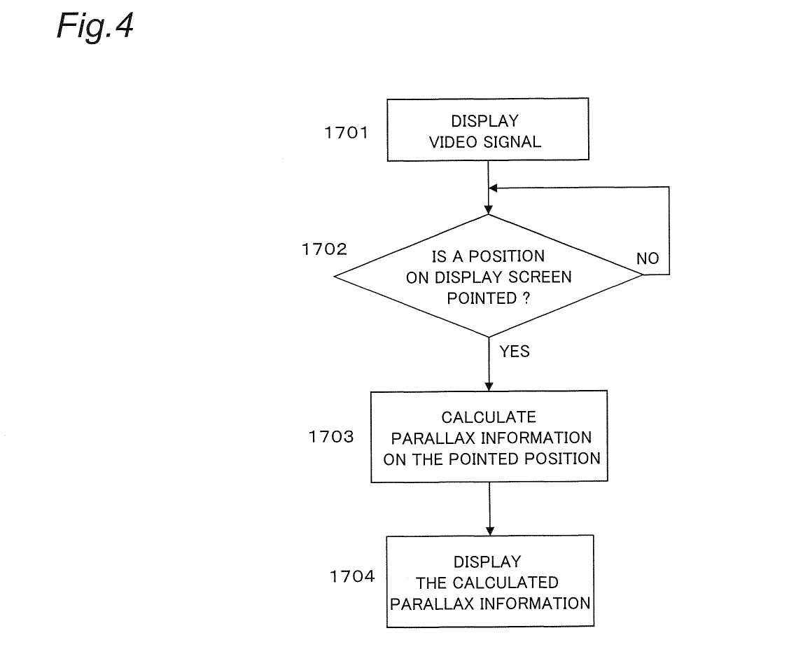

A display operation performed on the display unit 5 by the display processor 4 is described. FIG. 4 is a flowchart illustrating an operation for displaying a video signal output from the display processor 4, performed by the display unit 5.

The display screen 1601 displays a video signal generated by the display processor 4 (step S1701).

In this state, the stereo camera 200 determines whether a position on the display screen is pointed by the user (step S1702). The position on the display screen is pointed by the touching operation of the operation unit 6 and an operation on the region 1602 by the operation member 301. When receiving the pointing of the position, the stereo camera 200 calculates parallax information on a position pointed by the user (step S1703).

The stereo camera 200 displays the calculated parallax information on the display screen 1601 (step S1704).

### 2. Display Format of Parallax Information

The display format of parallax information on a display screen 1601 is described with reference to various examples.

### 2-1. Display of Only Magnitude of Parallax as Parallax Information

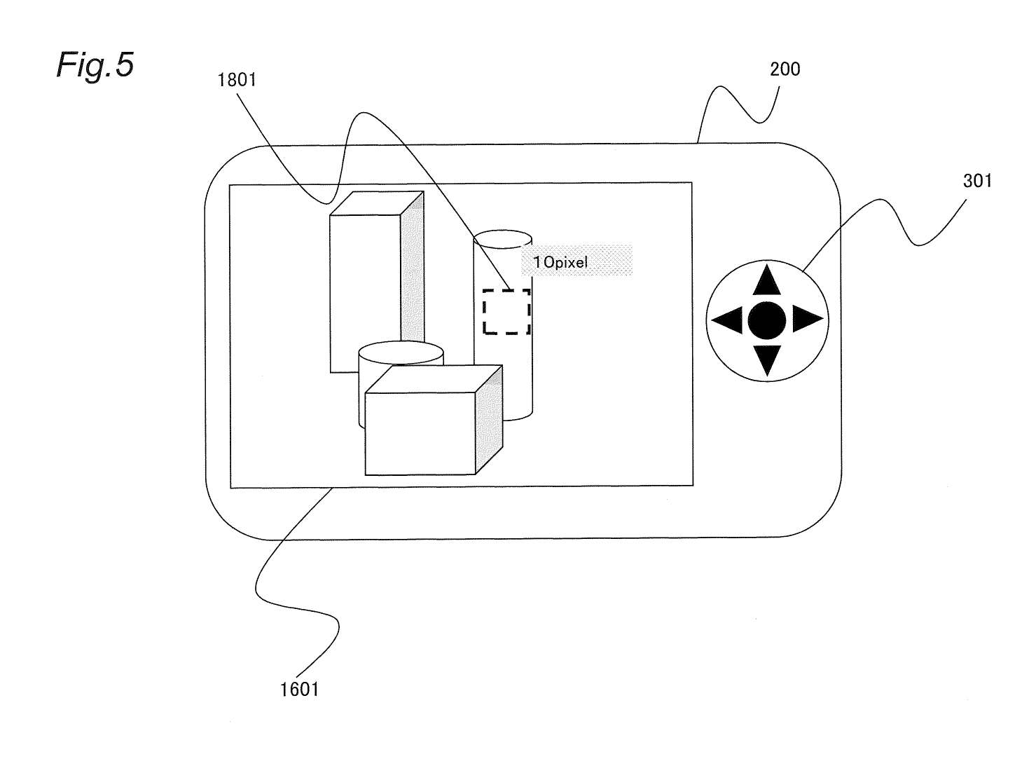

FIG. 5 is a diagram illustrating a display example of parallax information on the display screen 1601 on the display unit 5. FIG. 5 illustrates an example where only a magnitude of parallax (an amount of parallax) is displayed as the parallax information. The region 1801 is a position touched by the user or a position pointed through the operation member 301. For example, when parallax information is displayed, the stereo camera 200 displays the parallax information in a vicinity of the region 1801. The vicinity of the region 1801 indicates a position close to the region 1801. In short, the vicinity of the region 1801 is positions at which the region 1801 can be recognized related with the parallax information when the user views the parallax information displayed on the display screen 1601. For example, as shown in FIG. 5, the parallax information may be displayed on an upper right portion of the region 1801. The parallax information may be displayed on any position such as an upper left, a lower left, a lower right, up, down, right and left portions of the region 1801. The parallax information may be displayed on a position where correspondence to the region 1801 is known by the user viewing the parallax information. For this reason, the parallax information may be displayed on the upper portion or the lower portion of the display screen 1601.

When parallax information is displayed on the display screen 1601, the stereo camera 200 may be displayed on not only the vicinity of the region 1801 but also any region of the display screen 1601. For example, the stereo camera 200 may display parallax information on a lower end portion or an upper end portion of the display screen 1601.

### 2-2. Display of Vector Format of Parallax Information

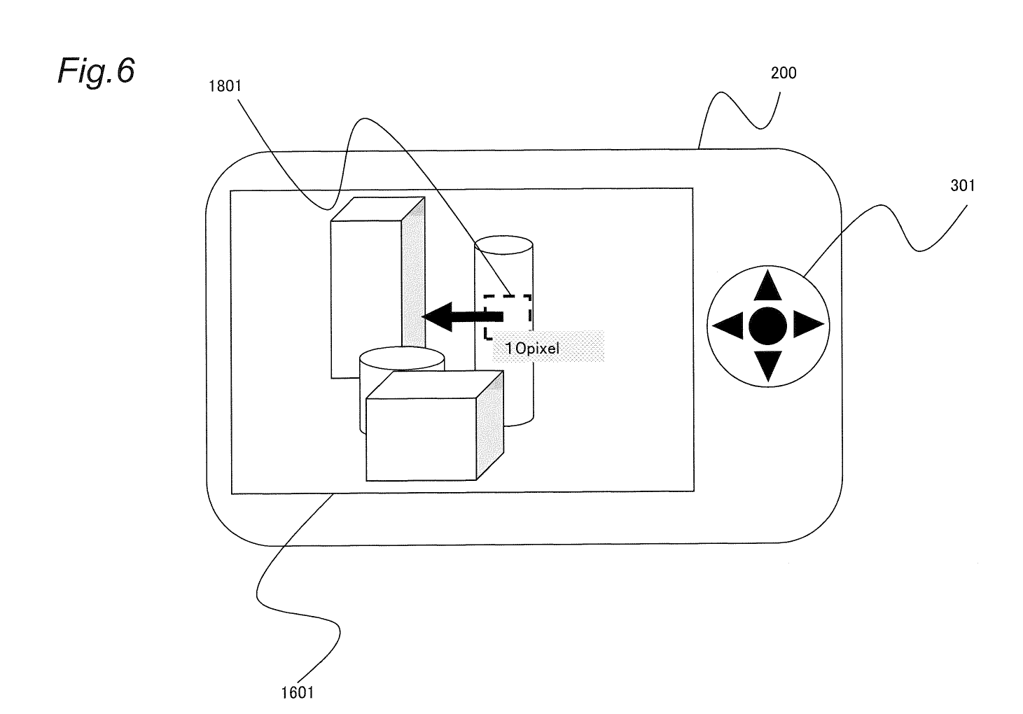

As shown in FIG. 6, when parallax information is displayed on the display screen 1601, the parallax information may be displayed in the vector format. In FIG. 6, the stereo camera 200 displays the parallax information using an arrow. In this case, the stereo camera 200 displays the magnitude of parallax (the amount of parallax) using a length of the arrow, and displays the direction of parallax (the orientation of parallax) using a direction of the arrow. For example, in the example of FIG. 6, in the stereo camera 200, a right-pointing arrow indicates a retreat direction, a left-pointing arrow indicates a popping-out direction, and a length of the arrow indicates the magnitude of parallax.

2-3. Display of Parallax Information about Most Popping-Out Position and Most Retreated Position Together

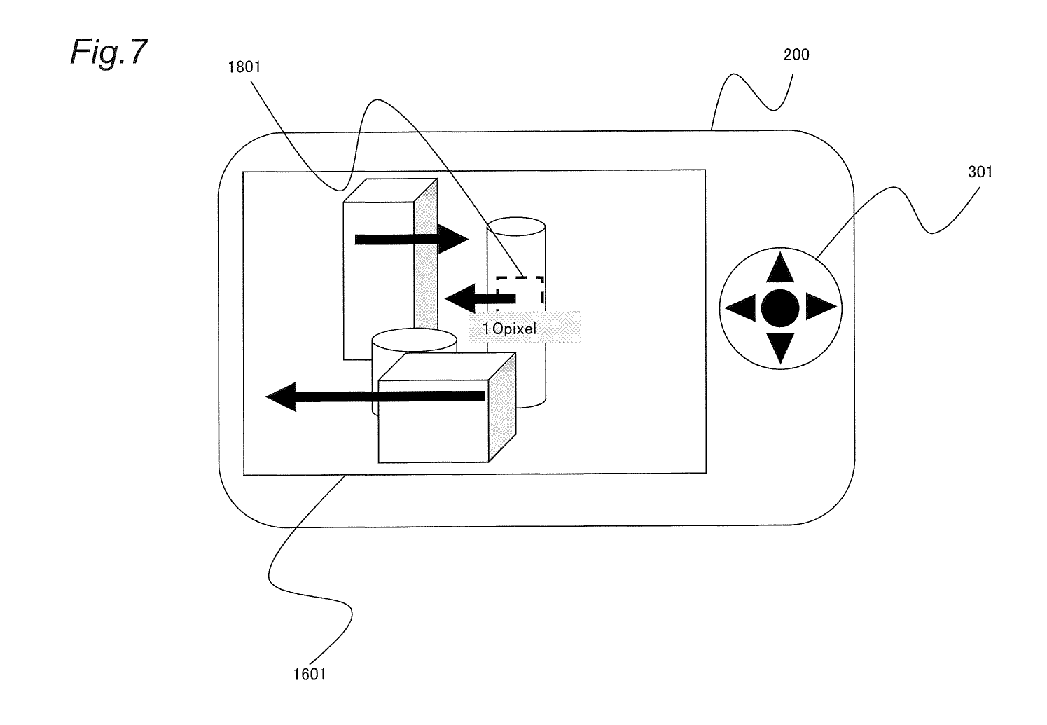

When receiving an operation from the user, the stereo camera 200 may, as shown in FIG. 7, display not only parallax information on the operated position but also parallax information on a position (portion) popped-out most and parallax information on a position (portion) retreated most on the display screen 1601. The stereo camera 200 may display any one of pieces of the parallax information on the position in which the touch operation or pointing operation the region 1602 by the user or pointed on the region 1602 by the user, the parallax information on the position (portion) popped-out most and the parallax information on the position (portion) retreated most on the display screen 1601.

2-4. Display in the Case where the Magnitude of Parallax Exceeds Allowable Value

When the magnitude of parallax in parallax information exceeds an allowable value, the stereo camera 200 may change the display format of parallax information on the display screen 1601. The allowable value is a limit value, for example, with which the user can view a stereo image as a three-dimensional video. The allowable value may be a value to be set by the operation member 301 in advance or a value to be set by the user.

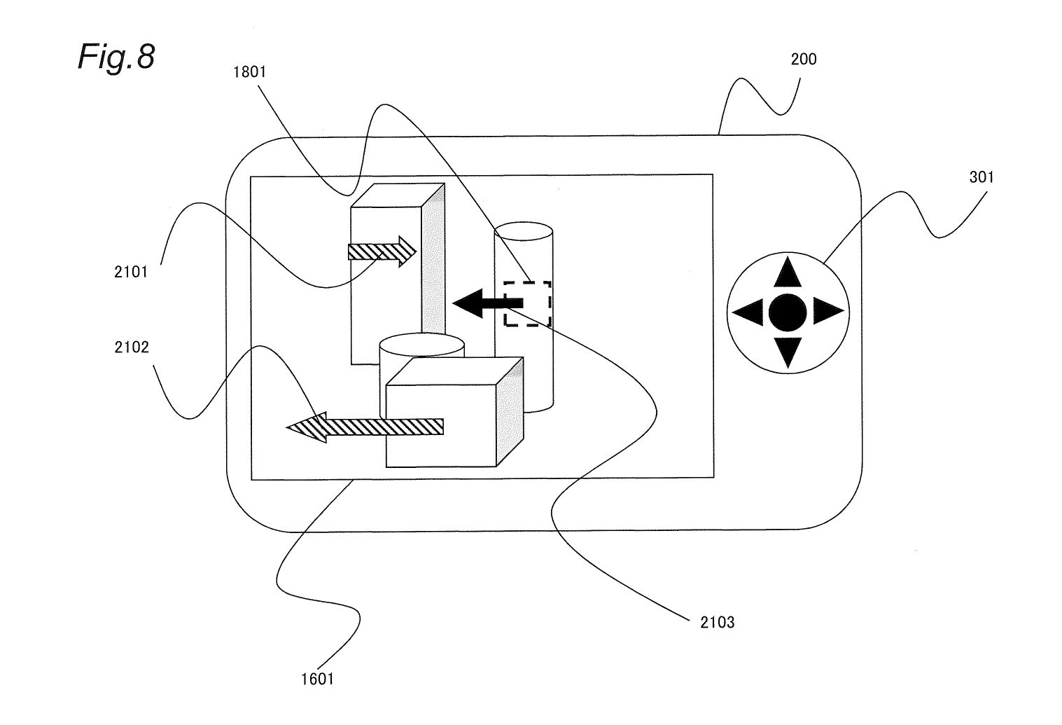

FIG. 8 is a diagram describing an example where a level that the magnitude of parallax in the parallax information exceeds the allowable value in the stereo camera 200.

The stereo camera 200 compares the allowable value of parallax and the magnitude of parallax in parallax information included in an image, and when the magnitude of parallax exceeds the allowable value as a result of the comparison, it changes the display format of the parallax information exceeding the allowable value. For example, as shown in FIG. 8, when the magnitude of parallax in parallax information relating to an arrow 2101 and an arrow 2102 exceeds the allowable value, the arrow 2101 and the arrow 2102 are expressed as arrows of slanting line differently from the display format of an arrow 2103 that does not exceed the allowable value.

When an arrow is displayed, the stereo camera 200 may change a color according to a degree of exceeding the allowable value. For example, the stereo camera 200 may display an arrow so that as the degree that the magnitude of parallax exceeds the allowable value is larger, the color of the arrow becomes deeper red. In short, the stereo camera 200 changes the display format of parallax information to be displayed on the display screen 1601 using the allowable value as a threshold. The display format may be changed into any display format as long as the user can recognize that parallax exceeds the allowable value.

### 2-5. Display of Predetermined Number of Pieces of Parallax Information in Decreasing Order of Parallax

When parallax information on a plurality of regions is displayed, the stereo camera 200 may display not only parallax information on a position pointed by the user's touching operation but a predetermined number (plurality) of parallax information in decreasing order of parallax. As a result, the user can easily determine the direction and the magnitude of parallax on a plurality of positions on the screen with reference to a plurality of arrows displayed on the display unit 5. The user can intuitively adjust the magnitude and the direction of parallax through the touch panel.

2-5-1. Display with Different Marks and Bar Graph

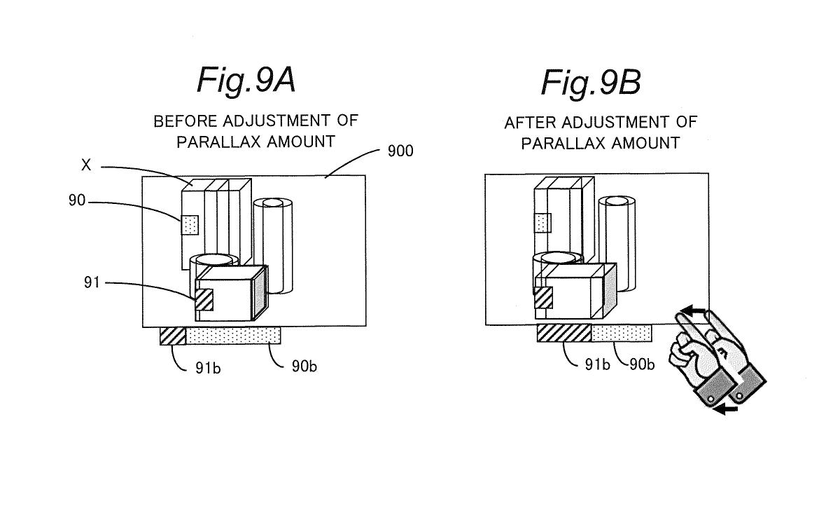

FIGS. 9A and 9B are diagrams describing an example that a predetermined number of marks and bar graphs are displayed in decreasing order of parallax as parallax information in the stereo camera 200. FIG. 9A illustrates an example of a synthesized image of a left-eye image and a right-eye image that is displayed on the display unit 5 by the display processor 4 (before adjustment of parallax information). FIG. 9B illustrates an example of a synthesized image that is displayed on the display unit 5 by the display processor 4 after the adjustment of parallax information. Details of the process for adjusting parallax information is described later.

In FIG. 9A, when the user touches a synthesized image screen 900 displayed on the display unit 5, the operation unit 6 detects the touching, and the input unit 8 outputs a signal relating to the operation information to the controller 9. As a result, a mark 90 is displayed on a position where parallax in the retreat direction is maximum on the screen in order to indicate that position, and a bar graph 90b indicating parallax information on the position of the mark 90 is displayed thereon. At the same time, a mark 91 is displayed on a position where parallax in the popping-out direction is maximum on the screen in order to indicate that position, and a bar graph 91b representing parallax information on the position of the mark 91 is displayed thereon. The bar graph 91b, of which right end is on a position where parallax is 0, extends from that position, to the left, and the bar graph 90b, of which left end is on a position where parallax is 0, extends from that position to the right.

2-5-2. Display with Different Zebra Patterns and Bar Graph

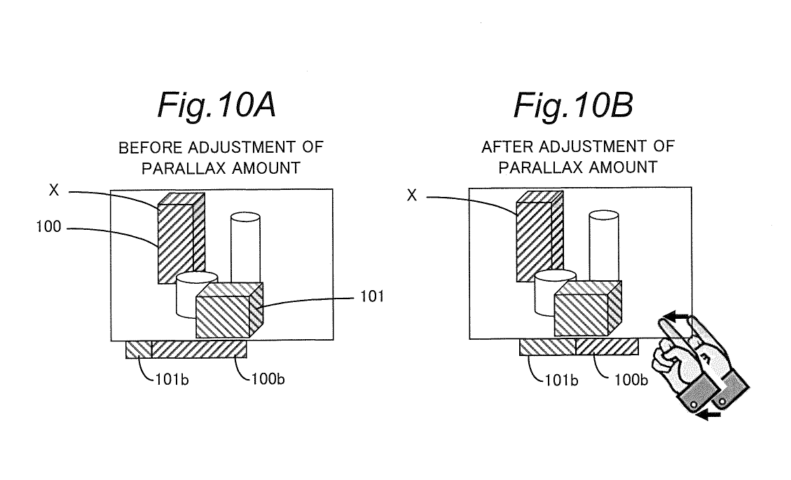

FIGS. 10A and 10B are diagrams describing an example where a predetermined number of color coding zebra patterns are displayed as parallax information in decreasing order of parallax in the stereo camera 200. FIG. 10A illustrates a second image by a stereoscopic video signal output from the signal processor 3 (before adjustment of parallax information), and FIG. 10B illustrates a second image of a stereoscopic video signal output from the signal processor 3 after adjustment of parallax information.

In FIG. 10A, when the user touches a synthesized image screen of a left-eye image and a right-eye image displayed on the display unit 5, the operation unit 6 detects the touching, and the input unit 8 outputs a signal relating to the operation information to the controller 9. As a result, slanting lines (so-called zebra pattern) 100 are displayed on a region where parallax in the retreat direction is maximum on the screen, and a bar graph 100b representing parallax information on the region of the zebra 100 is displayed thereon. At the same time, a zebra 101 is displayed on a region where parallax in the popping-out direction is maximum on the screen, and a bar graph 101b representing parallax information of the zebra 101 is displayed thereon.

### 2-6. Display of Parallax Information of Focus Point in Addition to Maximum Parallax Information

The stereo camera 200 determines a focus region based on a stereo image, and may display parallax information in the focus region.

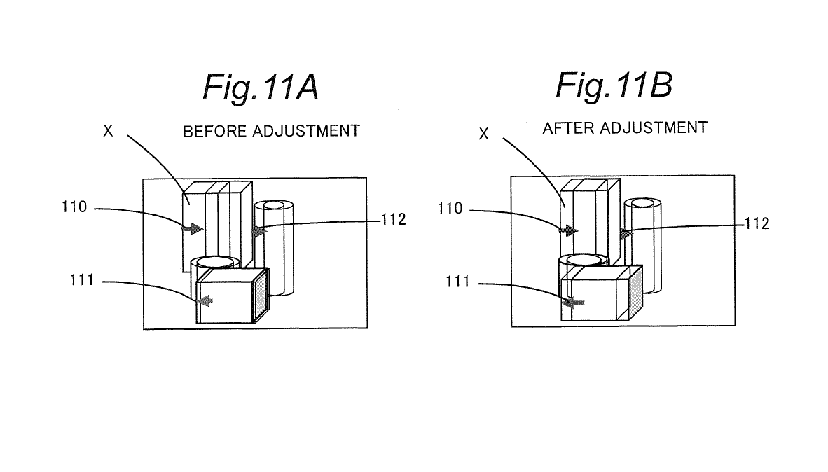

FIGS. 11A and 11B are diagrams for describing an example where parallax information at the focus point is displayed in addition to parallax information on the region where parallax is maximum in the stereo camera 200. FIG. 11A is a diagram illustrating an example of a synthesized image displayed on the display unit 5 by the display processor 4 before adjustment, and FIG. 11B is a diagram illustrating a synthesized image displayed on the display unit 5 by the display processor 4 after adjustment. FIGS. 11A and 11B illustrate a case where not only parallax information on a position where parallax information is desired to be adjusted but also parallax information on a plurality of positions on the screen is described.

In FIG. 11A, when the user touches the stereoscopic video screen display on the display unit 5, the operation unit 6 detects the touching, and the input unit 8 outputs a signal relating to operation information to the controller 9. As a result, an arrow 110 is displayed on a position where parallax in the retreat direction is maximum on the screen in order to indicate parallax information on that position. At the same time, an arrow 111 is displayed on a position where parallax in the popping-out direction is maximum on the screen in order to indicate parallax information on that position. In addition, a green arrow 112 representing, for example, parallax information on a position of the focus point is displayed together.

These arrows are generated by the GUI generator 7 and are superimposed on a stereoscopic video signal by the display processor 4. The arrow images are generated so that the right-pointing arrow indicates the retreat direction, and the left-pointed arrow indicates the popping-out direction, and the lengths of the arrows indicate the magnitude of parallax. The arrow in the retreat direction may be shown by red, the arrow in the popping-out direction may be shown by blue, and the arrow of the focus point may be shown by green.

The user determines whether the magnitude of parallax is increased or decreased and when being increased or decreased, determines a direction of increasing or decreasing with reference to the above three arrows. In a case of FIG. 11A, a retreated amount of an innermost object is excessive, and this object has the maximum parallax on the entire screen. At this time, the user makes adjustment so that the excessive retreated amount is alleviated as shown in FIG. 11B.

In this case, the user performs an operation for reducing the magnitude of parallax indicated by the right-pointing arrow 110 in the procedure similar to that described with reference to FIG. 8. At this time, as shown in FIG. 11B, the parallax in the retreat direction on the position of the arrow 110 is reduced, and the length of the arrow 112 is shortened. At this time, the parallax in the retreat direction indicated by the arrow 112 pointing to the same direction as the arrow 110 is reduced, and the length of the arrow 110 is shortened to be displayed. On the other hand, as to the arrow 111 pointing to the direction opposite to the arrow 110, the parallax in the popping-out direction increases, and the length of the arrow 111 becomes long.

When parallax is adjusted in such a manner, the user adjusts parallax while concerning about the arrow 110 and the arrow 111 indicating large parallax on the screen. However, as a result, parallax of an object on a focus point as a main object might be large. Therefore, parallax information on the focus point is displayed by, for example, a green arrow so that parallax information about the main subject can be checked during the parallax adjustment.

With the above-described operation, when the user adjusts parallax information, parallax information about the maximum parallax can be easily viewed, whereas the parallax information about the main subject can be prevented from being adjusted into a state that is different from a user's intention.

### 3. Adjustment of Parallax Information

The adjustment of parallax information displayed on the display surface of the display unit 5 by the stereo camera 200 is described below with reference to the drawings.

When parallax information is displayed on the display screen of the display unit 5, the stereo camera 200 can adjust the magnitude of the displayed parallax according to an operation of the operation unit 36 performed by the user.

3-1. Adjustment of Parallax through Dragging Operation

When parallax information is displayed on the display screen of the display unit 5 and the user performs the dragging operation on the operation unit 6, the stereo camera 200 adjusts the magnitude of displayed parallax.

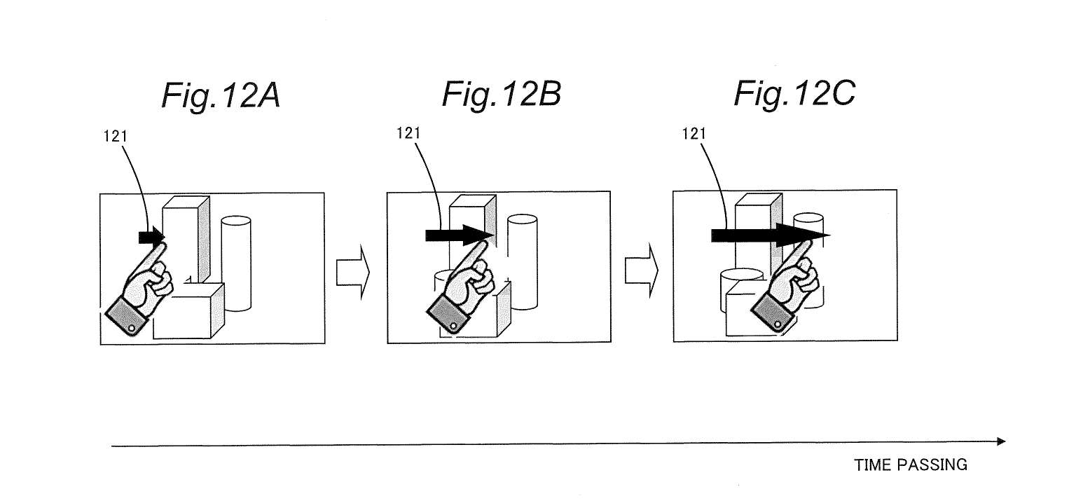

FIGS. 12A to 12C are diagrams for describing adjustment of parallax information through the dragging operation performed by the user.

When the user touches the operation unit 6, the stereo camera 200 displays parallax information (arrow) 121 on a touched position on the display unit 5 as shown in FIG. 12A. At this time, when the user performs the dragging operation while maintaining the touch with the display unit 5, the stereo camera 200 changes a size of the arrow 121 displayed on the display unit 5 as shown in FIGS. 12B and 12C. That is to say, a magnitude of parallax is changed. When parallax information is changed, as described later, the stereo camera 200 changes a shooting parameter in the imaging unit 1 or processes a video signal displayed on the display unit 5 so that the video signal corresponds to the magnitude of the changed parallax information. This changing operation is described later.

The above described that parallax information is increased by the dragging operation. However, an operation of the stereo camera 200 is not limited to the above operation and the stereo camera 200 may decrease the magnitude of parallax when the dragging operation is performed. In this case, the user performs the dragging operation in a direction opposite to the direction of the arrow.

With the above operation, the user can easily determine the magnitude and direction of parallax on a position pointed by the touching operation through the arrow displayed by the display unit, and can intuitively adjust the magnitude and direction of parallax through the touch panel.

3-2. Adjustment of Parallax through the Operation Member

The stereo camera 200 can adjust parallax information also through an operation other than the dragging operation.

For example, the stereo camera 200 can adjust the magnitude of parallax information using the operation member 301 shown in FIG. 6. When an arrow is displayed on the display screen of the display unit 5 and the operation member 301 is operated to the same direction as the arrow, the stereo camera 200 makes a control so that the parallax information is increased. On the other hand, when the operation member 301 is operated to a direction opposite to the direction of the arrow, the stereo camera 200 makes a control so that the parallax information is reduced.

Concretely, for example, the user performs an operation for tracing the arrow displayed on the display unit 5 to the left direction in order to reduce the parallax information indicated by the right-pointing arrow. In this case, the operation unit 6 detects this operation, the input unit 8 outputs it as operation information to the controller 9. As a result, the controller 9 controls the signal processor 3 to perform parallax adjustment to reduce the magnitude of parallax in parallax information in the retreat direction.

3-3. Adjustment of Parallax through Tap Operation

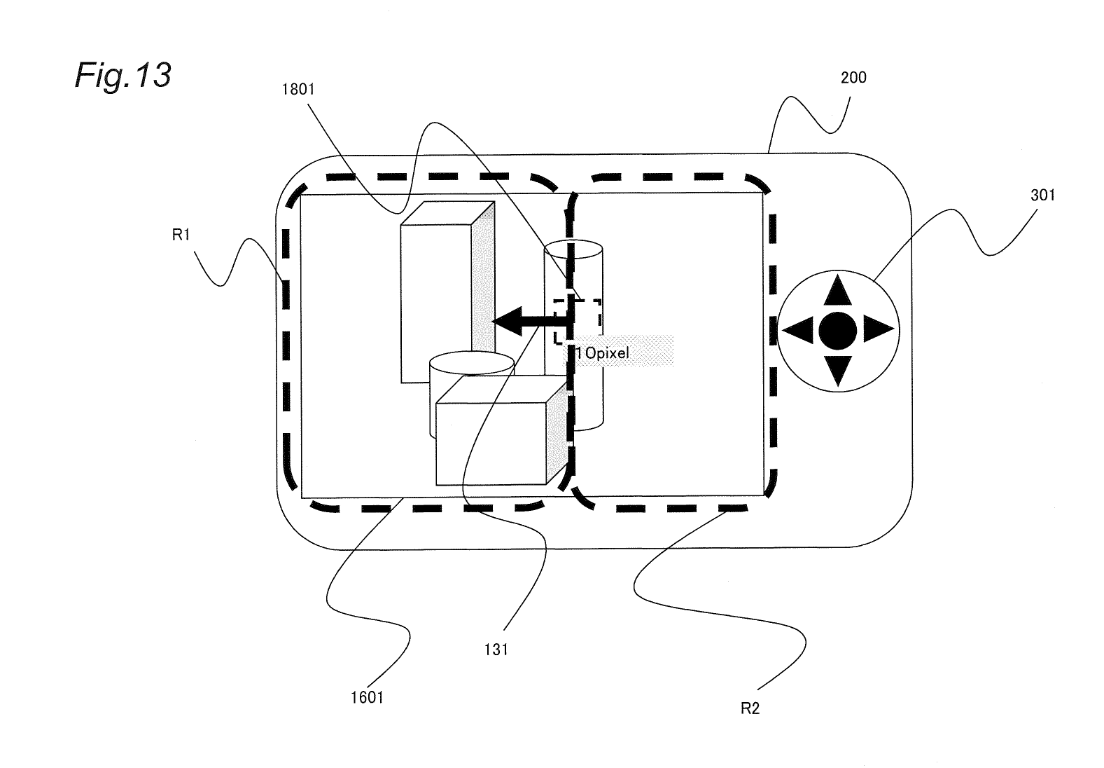

The stereo camera 200 may be configured so that an arrow displayed on the display screen of the display unit 5 is tapped sequentially in terms of time and thereby parallax information is gradually adjusted. The tap operation is for sequentially performing the touch operation at any number of times. That is to say, when the user sequentially taps a displayed arrow through the operation unit 6, the stereo camera 200 makes a control so that parallax information of the tapped arrow is adjusted by preset magnitude. When the tap operation is received sequentially twice, a control may be made so that the parallax information is increased. When the tap operation is received sequentially three times, a control may be made so that the parallax information is decreased. As shown in FIG. 13, when the tap operation is performed on a region R1 which is in the direction of an arrow 131 based on the region 1801 relating to operation information 131, a control may be made so that the parallax information is increased. When the tap operation is performed on a region R2 which is in a direction opposite to the direction of the arrow 131, a control may be made so that the parallax information is decreased.

### 3-4. Adjustment of Amount of Parallax to 0

When receiving the touching operation via the operation unit 6, the stereo camera 200 may make a control so that the length of the touched arrow (a magnitude of parallax) becomes 0.

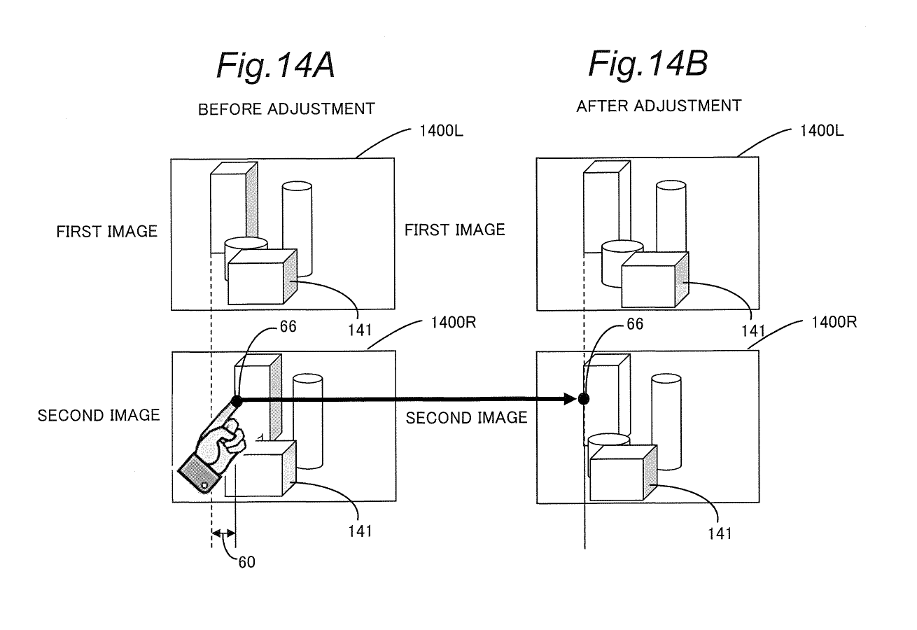

FIGS. 14A and 14B are diagrams for describing the operation for setting parallax on a touched position to 0 in the stereo camera 200. FIG. 14A is the diagram illustrating a stereoscopic video output from the signal processor 3 before adjustment of parallax information, and FIG. 14B is the diagram illustrating a stereoscopic video output from the signal processor 3 after the adjustment of parallax information.

In FIGS. 14A and 14B, the display processor 4 selects only a second image from a left-eye image (hereinafter, “first image”) 1401L and a right-eye image (hereinafter, “second image”) 1401R to display it on the display unit 5. Either the left-eye image or the right-eye image may be the first image or the second image.

In the stereoscopic video before adjustment, a magnitude of parallax of an innermost cube 141 is a difference 60 between the first image 1401L and the second image 1401R. An operation for displaying the cube 141 on the display screen at a time of reproduction that is desired to be performed by the user is described.

When the user touches a position 66 desired to be adjusted on the second image 1401R displayed on the display unit 5, the operation unit 6 detects this operation, and the input unit 8 outputs it as operation information to the controller 9. As a result, the controller 9 controls parallax so that a magnitude of parallax on the touched position 66 is adjusted to 0.

When the user touches the touch panel, parallax on any position on an image can be 0, namely, a portion corresponding to that position on the image can be displayed on the screen of the display device (position of parallax 0) as described above.

### 3-4. Adjustment of Parallax of Image According to Adjustment of Parallax Information

A process to be executed after the change of parallax information in the above manner is described.

### 3-4-1. Signal Process According to the Change of Parallax Information

A signal process that is executed by the stereo camera 200 in the case where parallax information is changed is described.

When parallax information is changed on the screen by a user's operation, the stereo camera 200 executes a signal process for shifting a first image and a second image so that the image is fitted to changed parallax information. This process is a shifting process.

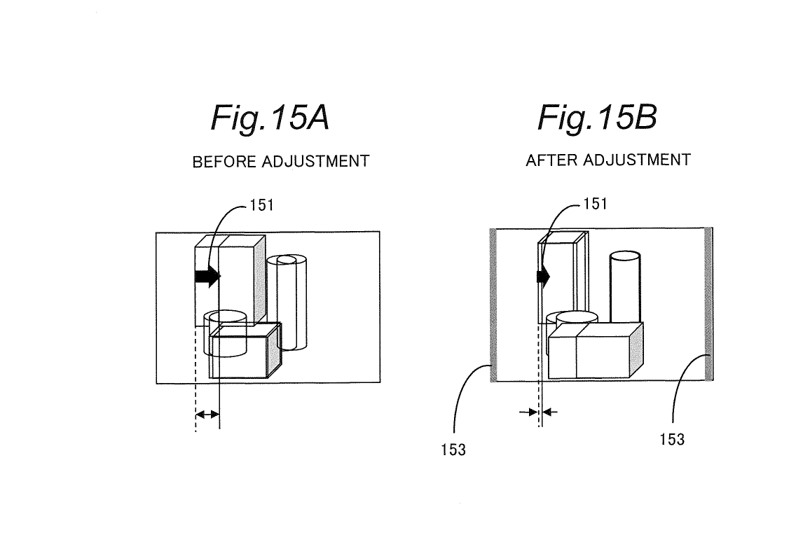

FIGS. 15A and 15B are diagrams for describing the shifting process executed by the stereo camera 200.

As shown in FIGS. 15A and 15B, when a magnitude of parallax (a length of an arrow) in parallax information (arrow) 151 is adjusted from a length shown in FIG. 15A to a length shown in FIG. 15B, the signal processor 3 shifts the first image, namely, the left-eye image to the right direction and the second image, namely, the right-eye image to the left direction so that the magnitude of parallax calculated from the first image and the second image become small. At this time, a portion without an image signal generated according to the parallax adjustment is, for example, masked with simple grey color. For this reason, a mask region (153) is displayed on both ends of a synthesized image as shown in FIG. 15B.

With such a process, the parallax information calculated from the first image and the second image can be also reduced according to the user's parallax adjustment.

3-4-2. Adjustment of Parallax Information According to Change of Shooting parameter

Parallax may be adjusted in such a manner that parallax information is adjusted not by the signal process but by adjusting a shooting parameter of the imaging unit 1.

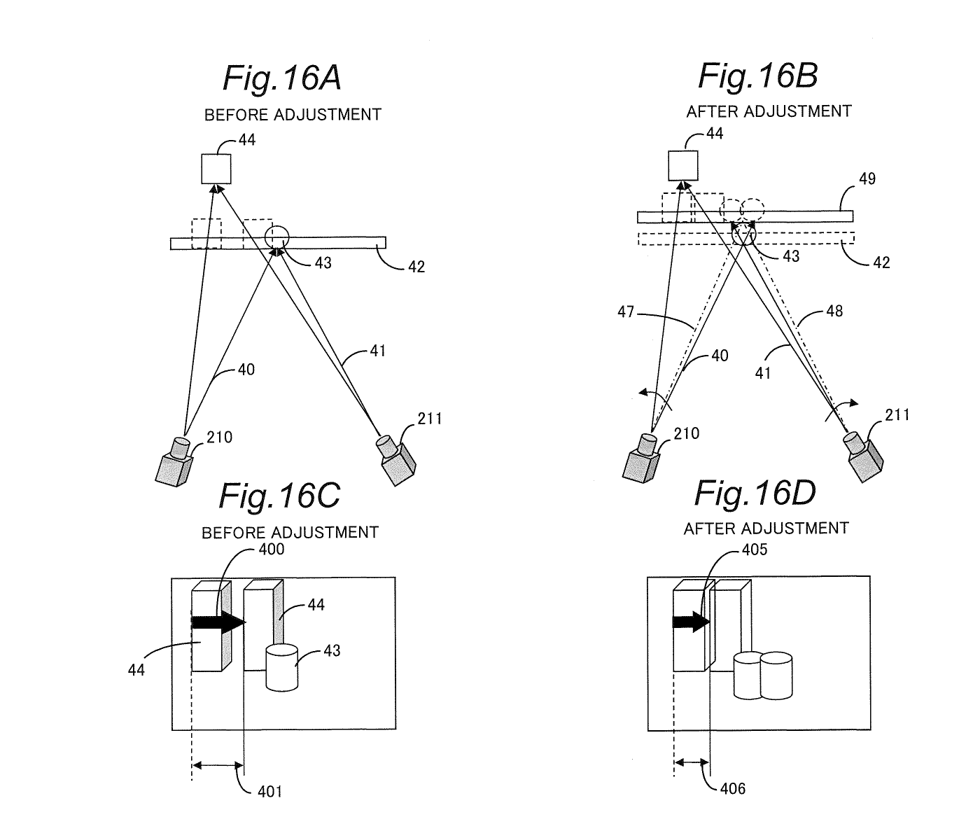

FIGS. 16A to 16D are diagrams for describing an operation for adjusting the shooting parameter of the imaging unit 1 to adjust actual parallax information in the stereo camera 200. FIG. 16A is a diagram illustrating a position relationship between the imaging unit 1 and an object before the adjustment of parallax information. FIG. 16B is a diagram illustrating a position relationship between the imaging unit 1 and the object after the adjustment of parallax information. FIG. 16C is a diagram illustrating a synthesized image output from the display processor 4 before the adjustment of parallax information. FIG. 16D is a diagram illustrating a synthesized image output from the display processor 4 after the adjustment of parallax information.

In the position relationship between the imaging unit 1 and the object shown in FIG. 16A before the adjustment, directions of the first optical system 210 and second optical system 211 are adjusted so that an optical axis 40 of the first optical system 210 and an optical axis 41 of the second optical system 211 cross on a virtual screen 42. An object captured in this state, namely, a circular cylinder 43 and a cube 44 appear on a synthesized image output from the display processor 4 before the adjustment of parallax information shown in FIG. 16C.

Before the adjustment of parallax information, as shown in FIG. 16A, the circular cylinder 43 near an intersection between the optical axis 40 and the optical axis 41 is not in the popping-out state nor the retreated state on the display side, and is aggregated as approximately one image on the synthesized image to be displayed. On the other hand, the cube 44 on the most retreated position is displayed with large parallax information 401 being maintained as shown in FIG. 16C.

When the user touches a vicinity of an image of the cube 44 for adjusting parallax, parallax information about an image of the captured cube 44 is displayed as an arrow 400 as shown in FIG. 16C. The user recognizes that a magnitude of parallax in parallax information indicated by the right-pointing arrow 400 is large (the cube 44 is excessively retreated), and performs the dragging operation on the arrow 400 displayed on the display unit 5 to the left direction in order to reduce the magnitude of parallax. The operation unit 6 detects this operation, and the input unit 8 outputs it as operation information to the controller 9. As a result, the controller 9 controls the camera controller 230 to perform parallax adjustment to reduce a magnitude of parallax in parallax information in the retreat direction.

Concretely, the camera controller 230, as shown in FIG. 16B, tilts the optical axis 40 of the optical system 210, that captures the first image, namely, the left-eye image, so that the optical axis 40 becomes the optical axis 47 in the position relationship between the camera optical system and the object after the adjustment. Further, the optical axis 41 of the optical system 211 that captures the second image, namely, the right-eye image is tilted right to be an optical axis 48. As a result, an optical axis 47 of the first optical system 210 and the optical axis 48 of the second optical system 211 cross on a virtual screen 49 farther than the virtual screen 42.

An object captured in this state, namely, the circular cylinder 43 and the cube 44 appear on a synthesized image signal output from the display processor 4 after the adjustment of parallax information as shown in FIG. 16D. In this case, the circular cylinder 43 is displayed in a popped-out state, and is recorded as a double image with parallax on a synthesized image. On the other hand, the cube 44 as a target for parallax adjustment is displayed with parallax information being reduced as shown by a difference 406 between the first image and the second image. In response to this, an arrow 405 generated by the GUI generator 7 is also displayed short.

At this stage, the user satisfies a level at which the arrow is short, namely, a level of parallax information adjustment, and stops the operation for tracing the arrow to the left direction. Thereafter, parallax information at this time is maintained and a stereoscopic video is captured. When parallax is adjusted by the optical system in such a manner, the mask region 153 at both ends of the image shown in FIG. 15B is not generated on the synthesized image shown in FIG. 16D.

### 3-4-3. Display of Information Representing Change of Position Having Maximum Parallax

As a result of adjusting actual parallax information according to the adjustment of parallax information by the user, the position having the maximum parallax on the image is occasionally changed. In this case, the stereo camera 200 may display information representing that the position having the maximum parallax is changed on the display unit 5.

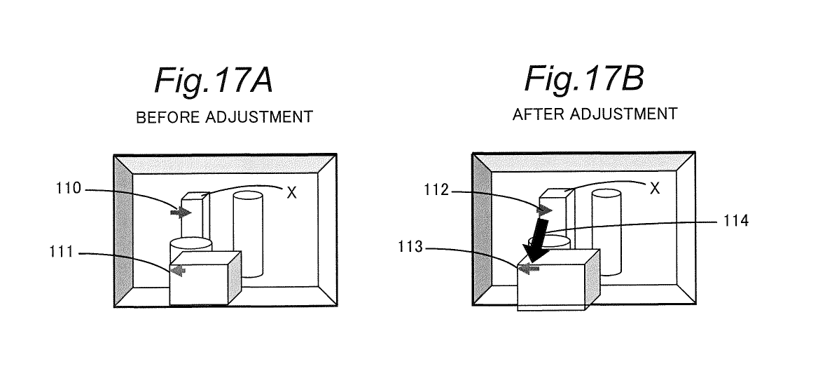

FIGS. 17A and 17B are diagrams for describing an operation for displaying a warning when the maximum magnitude of parallax is switched by parallax adjustment in the stereo camera 200. The display unit 5 is composed of stereoscopically displayable device, and conceptually illustrates a video signal of stereoscopic display. FIG. 17A illustrates a stereoscopic video displayed by the display unit 5 before the adjustment of parallax information, and FIG. 17B illustrates a stereoscopic video displayed by the display unit 5 after the adjustment of parallax information. FIGS. 17A and 17B illustrate a case where not only parallax information on a position desired to be adjusted but also parallax information on a plurality of positions on a screen are displayed when parallax information is adjusted.

In FIG. 17A, when the user touches a stereoscopic video signal screen displayed on the display unit 5, the operation unit 6 detects this operation, and the input unit 8 outputs it as operation information to the controller 9. As a result, the arrow 110 is displayed on a position where parallax in the retreat direction on the screen is maximum in order to indicate parallax information on that position. At the same time, the arrow 111 is displayed on the position where parallax in the popping-out direction on the screen is maximum in order to indicate parallax information on that position.

The images of the arrows 110 and 111 are generated by the GUI generator 7, and are superimposed on a stereoscopic video signal to be displayed by the display processor 4. Arrow images are generated so that the right-pointing arrow indicates the retreat direction, the left-pointing arrow indicates the popping-out direction, and the lengths of the arrows indicate parallax information. Since two kinds of arrows are displayed, the arrow of the retreat direction may be red, and the arrow of the popping-out direction may be blue to distinguish colors of the arrows.

The user then determines whether parallax information is increased or decreased using the two arrows as references, and when increased or decreased, determines a direction. Before the adjustment in FIG. 17A, an innermost object X is excessively retreated, and this object X has the maximum parallax on the entire screen. For this reason, the user makes adjustment so that the excessive retreated state is alleviated.

In this case, when the user performs an operation for reducing parallax information represented by the right-pointing arrow 110 in a similar procedure to that described in FIG. 8, parallax information in the retreat direction on the position of the arrow 110 reduces, and as shown in FIG. 17B, the arrow 112 is displayed short. On the other hand, parallax information in the popping-out direction increases due to parallax adjustment, and accordingly display of an arrow 113 is changed into long one.

When an amount of parallax adjustment by the user is large, although parallax information on the position of the arrow 110 is maximum on the entire screen before the adjustment, the position having the maximum parallax on the screen during the adjustment is occasionally changed into the position of the arrow 113. In this case, when the controller 9 determines change of the position having the maximum parallax, it controls the GUI generator 7 so that an arrow 114 for warning the change of the maximum parallax information is displayed on the display unit 5 via the display processor 4. As to the warning, the arrow 114 may be deleted after it is blinked only for a constant time, or a warning sound may be generated simultaneously with the display.

With the above-described operation, when the position where parallax information is maximum is moved as a result of adjusting parallax information by the user, the warning of this state can prevent parallax from being adjusted until parallax information on another position is excessive due to much attention to a certain portion on the screen.

### 3-4-4. Adjustment of Parallax Information in Case Where Magnitude of Parallax is Displayed as Bar Graph

When the stereo camera 200 displays the screen shown in FIGS. 9A and 9B, hereinafter parallax information can be adjusted as follows.

The user determines whether parallax information is increased or decreased using two bar graphs 90b and 91b shown in FIG. 9A as references, and if it is increased or decreased, determines a direction. In FIG. 9A, a retreated amount of the innermost object X is excessive, and the user makes adjustment so that the excessive retreated amount is alleviated as shown in FIG. 9B. Concretely, the user performs an operation for tracing any position on an image displayed on the display unit 5 to the left direction so that a magnitude of parallax indicated by the bar graph 90b is reduced. The operation unit 6 detects this operation, and the input unit 8 outputs it as operation information to the controller 9. As a result, the controller 9 controls the signal processor 3 to perform parallax adjustment to reduce a magnitude of parallax in the retreat direction.

With this control, the magnitude of parallax in the retreat direction on the position of the mark 90 reduces, and the bar graph 90b is displayed short as shown in FIG. 9B. On the other hand, the parallax adjustment for reducing the retreat direction increases the magnitude of parallax in the popping-out direction, and the bar graph 91b in FIG. 9A changes into longer display as shown in FIG. 9B. When the user stops the screen tracing operation when the lengths of the bar graphs 90b and 91b become intended lengths, the parallax information at this time is maintained and thereafter stereoscopic videos are captured.

When a screen shown in FIG. 10 is displayed in the stereo camera 200, hereinafter parallax information can be adjusted in the following manner.

The user determines whether parallax information is increased or decreased using the two bar graphs 100b and 101b shown in FIG. 10A as references, and determines a direction if increased or decreased. In FIG. 10A, the retreated amount of the innermost object X is excessive, and the user makes adjustment so that the excessive retreated amount is alleviated as shown in FIG. 10B. The user's operation in this case is the same as that described in FIGS. 9A and 9B, and accordingly parallax information is adjusted and the display of the bar graphs are changed similarly to FIGS. 9A and 9B.

The above-described operation enables adjustment of parallax information on a plurality of positions on the screen displayed on the display unit 5 to be easily and intuitively adjusted through the touch panel after the direction and the magnitude of parallax information are determined.

### 3-5. Other Operations

The other operations in the stereo camera 200 are described below with reference to the drawings.

3-5-1. Stopping of Display of Parallax during Movement

The stereo camera 200 may make a control so that parallax information is not displayed on the display unit 5 while the stereo camera 200 is moving.

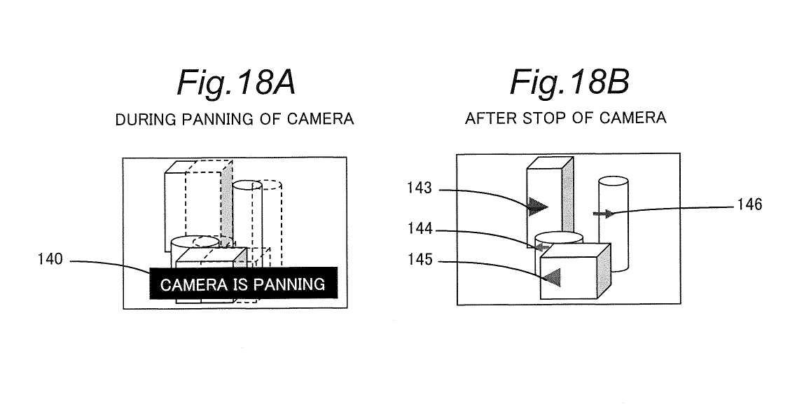

FIGS. 18A and 18B are conceptual diagrams describing an example where parallax is not displayed while the stereo camera 200 is moving. FIG. 18A illustrates a second image to be displayed on the display unit 5 by the display processor 4 while the stereo camera 200 is moving. FIG. 18B illustrates a second image to be displayed on the display unit 5 by the display processor 4 after the stereo camera 200 stops.

In FIG. 18A, the user resets a shooting area while panning the stereo camera 200 to the right direction during the adjustment of parallax information. At this time, the controller 9 of the stereo camera 200 detects that the entire image moves by the same amount according to motion vector detection through the parallax information calculator 2 or the signal processor 3, or detects horizontal movement of the stereo camera 200 based on information from an acceleration sensor, not shown. It is determined that the stereo camera 200 is panned based on the detected result, and as shown in FIG. 18A, a warning 140 that “The camera is moving” is displayed. At this time, no detection result of parallax information is displayed.

When the user stops the operation for panning the stereo camera 200 to the right direction, the stereo camera 200 detects this operation, and arrows 143, 144, 145 and 146 as the detected results of parallax information are displayed on the display unit 5 as shown in FIG. 18B.

In the examples of FIGS. 18A and 18B, similarly to FIG. 8, the controller 9 stores an allowable value of parallax information in advance. In FIG. 8, a level where the parallax information exceeds the allowable value is indicated by different colors of the arrows, but in FIGS. 18A and 18B, this level is indicated by a thickness of the arrow, and the arrow is displayed on two positions in decreasing order of the magnitude of parallax in each of the retreat direction and the popping-out direction. In the example of FIG. 18B, totally four arrows including the arrow 143 representing the maximum parallax information in the retreat direction, the arrow 146 representing the second largest parallax information in the retreat direction, the arrow 145 representing the maximum parallax information in the popping-out direction, and the arrow 144 representing the second largest parallax information in the popping-out direction are displayed.

When the user performs the operation for moving the position and the attitude of the stereo camera, such as panning and zooming during the parallax adjustment, the user does not adjusts parallax but resets a shooting area (framing) during the moving operation. For this reason, when parallax adjustment display is performed, the user's operation is hindered. In the above example, the parallax adjustment display is paused, this hindrance can be prevented.

### 3-5-1. Display Format of Video

Videos to the display unit 5 and the display format of parallax information are described below.

### 3-5-1. Shading Process on Portion Having Larger Parallax Than Parallax on Touched Position

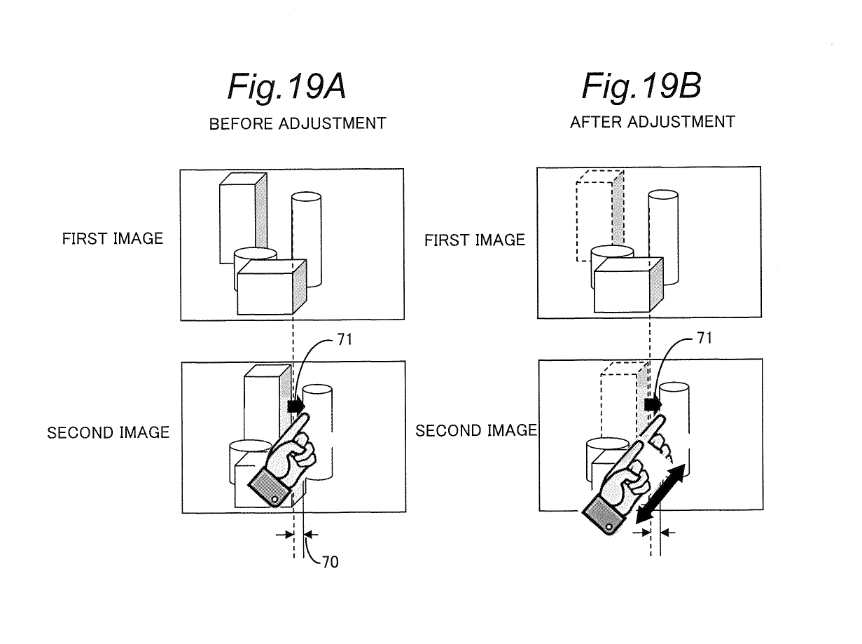

A shading process may be executed on a region having larger parallax than parallax on a touched position. The shading process is described below with reference to FIGS. 19A and 19B. In FIGS. 19A and 19B, the display processor 4 selects only the second image to display it on the display unit 5.

When the user touches a boundary between an object desired to be high definition and an object to be shed on the second image displayed on the display unit 5, the operation unit 6 detects the touching, the input unit 8 outputs it as operation information to the controller 9. As a result, an arrow 71 representing parallax information on the touched position is displayed on the touched position. The arrow 71 is generated by the GUI generator 7, and is superimposed on the second image by the display processor 4. The arrow images are generated so that the right-pointing arrow indicates the retreat direction, the left-pointing arrow indicates the popping-out direction, and the lengths of the arrows indicate the magnitude of parallax.

The user then touches the arrow 71 displayed on the display unit 5 at a plurality of times to instruct addition of a signal process for shading a part of an image. The operation unit 6 detects this touching, and the input unit 8 outputs it as operation information to the controller 9. As a result, the controller 9 makes a control so that the shading process is executed on a region having parallax larger than the parallax information 70 on the touched position.

Concretely, the signal processor 3 uses a low-pass filter on regions of the first image and the second image having parallax larger than the magnitude of parallax 70 on the touched position to output the signal. As a result, an object closer to the display surface than the position of the arrow 71 is displayed highly definitely, and the definition of the object that is retreated or popped out at parallax larger than that on the position of the arrow 71 is reduced (shaded). Therefore, easily viewable 3D image can be captured.

With the above-described operation, the user determine the direction and the magnitude of parallax on the screen based on the arrow shown by the display unit to be capable of easily and intuitively adjusting visibility of the 3D image through the touch panel.

3-5-2. Enlarged Display of Portion on which Parallax Information is Displayed

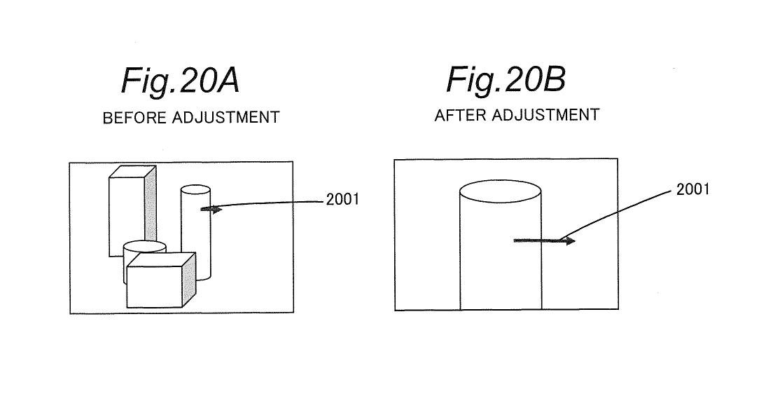

In FIGS. 20A and 20B, when the portion displaying parallax information on the display unit 5 is touched, the parallax information as well as this desired portion may be enlarged to be displayed.

When the user touches a region where parallax is desired to be adjusted on the image displayed on the display unit 5, the operation unit 6 detects the touching, and the input unit 8 outputs the operation information to the controller 9. As a result, an arrow 2001 indicating parallax information on the touched position is displayed on the touched position.

The user then touches the arrow 2001 displayed on the display unit 5 at a plurality of times, and instructs addition of a signal process for enlarging a part of an image. The operation unit 6 detects this operation, and the input unit 8 outputs it as operation information to the controller 9. The controller 9 makes a control to execute the process for enlarging an image of a region corresponding to a touched position. At this time, the arrow 2001 is also enlarged to be displayed.

With the above-described operation, the user determines the direction and the magnitude of parallax on the screen based on the arrow displayed on the display unit to be capable of intuitively and easily adjusting visibility of a 3D image through the touch panel.

In the stereo camera 200 according to this embodiment, parallax information (the direction of parallax (the retreat direction, the popping-out direction), and the magnitude of parallax) is calculated for each region of an image, and on a position pointed by a user's operation on the touch panel, a position where parallax is maximum, or a predetermined number (plurality) of positions in decreeing order of parallax, the positions, the direction of parallax and the magnitude of parallax are displayed in a determinable format. As a result, the user determines the direction of parallax and the magnitude of parallax on the screen displayed on the display unit, and can intuitively and easily reflects the adjustment of parallax information and shooting intension through the touch panel.

When a portion with large parallax is generated on a shooting image, the user immediately selects a preferable method from countermeasure methods such as a method for shooting an image of which parallax is adjusted for each stereoscopic viewing, a method for shading a portion where stereoscopic viewing is difficult, and a method for daringly shooting even if stereoscopic viewing is slightly difficult, and reflects the selected method to a shooting image. The stereo image display device that can perform such an operation can be realized.

### 4. Conclusion

The stereo camera 200 according to the embodiment includes the imaging unit 1, the display unit 5, the operation unit 6, the parallax information calculator 2, and the controller 9. The imaging unit 1 obtains image data representing a stereo image. The display unit 5 displays an image based on the image data obtained by the imaging unit 1. The operation unit 6 receives pointing position on the image displayed on the display unit 5. The parallax information calculator 2 obtains parallax information on a portion corresponding to the position pointed by the operation unit 6 on the image data obtained by the imaging unit 1. The controller 9 controls the display unit 5 so that parallax information obtained by the parallax information calculator 2 as well as the image is displayed. The display unit 5 displays parallax information in a format representing a magnitude and a direction of parallax. The operation unit 6 receives a command for changing the magnitude of parallax represented by the parallax information. The controller 9 changes the magnitude of parallax on a portion corresponding to the pointed position in the image data based on the changing command received by the operation unit 6.

With this configuration, the stereo camera 200 can point the position on the image based on the image data representing a stereo image. Further, the parallax information on the portion corresponding to the pointed position can be displayed together with the image displayed by the display unit 5. As a result, the user can simultaneously check parallax information on the pointed portion while checking the image based on the image data representing the stereo image.

According to the change in the magnitude of parallax information, the stereo camera 200 can change the magnitude of parallax in image data obtained by the imaging unit 1. As a result, the user can adjust parallax of a stereo image by checking parallax information displayed on the display unit 5 and changing only the magnitude of the parallax information.

Further, for example, the controller 9 controls the display unit 5 so that parallax information obtained by the parallax information calculator 2 is displayed near the position pointed by the operation unit 6.

With this configuration, the stereo camera 200 can display the pointed position and the parallax information with them being related to each other. As a result, the user just views an image based on image data representing a stereo image to be capable of checking a position of the displayed parallax information on the position of the image.

For example, the controller 9 controls the display unit 5 so that parallax information obtained by the parallax information calculator 2 is displayed in a vector format.

With this configuration, the stereo camera 200 can display the obtained parallax information in the vector format. As a result, the user can check the position of the displayed parallax information on the image, the magnitude and direction of the parallax information by only viewing an image based on the image data representing a stereo image.

For example, the image data representing the stereo image is obtained from the imaging unit 1, the operation unit 6 receives a command for changing a magnitude of parallax represented by the parallax information, and the controller 9 controls the shooting parameter in the imaging unit so that the magnitude of parallax is changed based on the changing command.

With this configuration, the stereo camera 200 can automatically change the shooting parameter in the imaging unit 1 according to the change in the magnitude of parallax composing the parallax information obtained by the parallax information calculator 2. At this time, the shooting parameter can be set so that the parallax of the stereo image to be captured by the imaging unit 1 is the magnitude of parallax in changed parallax information. As a result, the user can adjust the shooting parameter in the imaging unit 1 by only changing the magnitude of parallax composing the parallax information displayed on the display unit 5.

For example, the stereo camera 200 further includes the operation unit 6 for setting information about the magnitude of parallax of the image data representing the stereo image. The controller 9 controls the display unit 5 so that the display format of the parallax information is changed according to a case where the magnitude of the parallax information obtained by the parallax information calculator 2 is larger than the magnitude of parallax set by the operation unit 6 and a case where the magnitude of the parallax information obtained by the parallax information calculator 2 is smaller than the magnitude of parallax set by the operation unit 6.

With this configuration, the stereo camera 200 can change the display format of parallax information displayed on the display unit 5 around information set by the operation unit 6. As a result, the user can check whether the magnitude of parallax in the displayed parallax information is larger than the magnitude of parallax in the image data representing the set stereo image by only viewing the parallax information displayed on the display unit 5.

For example, the display unit 5 and the operation unit 6 are integrally configured as the touch panel that can detect user's touching operations at least while displaying an image based on an image data.

With this configuration, parallax information can be intuitively and easily adjusted through the touch panel.

For example, when detecting the touching operation on the display portion of parallax information continuously at a plural number of times during the display of parallax information, the operation unit 6 receives the touching operation as the changing command.

With this configuration, the stereo camera 200 can regard the continuous touching operation on the display portion of the parallax information during the display of parallax information as the changing command. As a result, the user can change the magnitude of parallax in the parallax information by performing the touching operation on the display portion of the parallax information at a plural number of times, checking the parallax information displayed on the display unit 5.

For example, when the operation unit 6 detects the dragging operation on the display portion of the parallax information during the display of the parallax information, it receives the dragging operation as the changing command.

With this configuration, the stereo camera 200 can regard the dragging operation on the display portion of the parallax information during the display of the parallax information as the changing command. As a result, the user can intuitively change the magnitude of parallax through the dragging operation, checking parallax information displayed on the display unit 5 in the vector format.

For example, the parallax information calculator 2 further obtains the maximum parallax information about the maximum parallax in parallax information about parallax of image data. When the position of a portion having the maximum parallax in the image data is changed due to the position of the portion having the maximum parallax in the image data is changed based on the changing command, the controller 9 controls the display unit 5 to display information representing that the portion having the maximum parallax in the image data is changed.

With this configuration, parallax information about the maximum parallax in parallax information about the parallax of the image data obtained by the imaging unit 1 is obtained, and the change in the position of the portion having the maximum parallax can be displayed on the display unit 5. As a result, when adjusting the magnitude of parallax information, the user can automatically recognize that the portion corresponding to the maximum parallax information is changed.

For example, the parallax information calculator 2 further obtains a predetermined number of pieces of parallax information in decreasing order starting from the largest magnitude of parallax in the parallax information about the image data. The controller 9 controls the display unit 5 to display parallax information on a portion corresponding to a pointed position and a predetermined number of pieces of parallax information.

With this configuration, the stereo camera 200 obtains parallax information having the largest magnitude of parallax and at least one of another parallax information having second largest parallax or later in the parallax information about parallax of the image data obtained by the imaging unit 1, and can display another parallax information as well as parallax information on the portion corresponding to the pointed position on the display unit 5. As a result, the user can check a relationship between the parallax information of the portion corresponding to the pointed position and another parallax information as well as the image data representing the stereo image on the display unit 5.

For example, the parallax information calculator 2 further obtains parallax information on a portion corresponding to a focus region on a stereo image in image data. The controller 9 controls the display unit 5 to display the parallax information on the portion corresponding to the pointed position and the parallax information on the portion corresponding to the focus region.

With this configuration, the stereo camera 200 obtains the parallax information on the portion corresponding to the focus region on the image data obtained by the imaging unit 1, and can display this obtained parallax information as well as the parallax information on the portion corresponding to the pointed position on the display unit 5. As a result, the user can check a relationship between the parallax information on the portion corresponding to the pointed position and the parallax information on the portion corresponding to the focus region as well as the image data representing the stereo image on the display unit 5.

For example, the controller 9 detects a movement of the stereo camera 200 and controls the display unit 5 to display only the image data obtained by the imaging unit 1.

With this configuration, the stereo camera 200 can control an ON/OFF state of the display of parallax information obtained according to the movement of the stereo camera 200. As a result, only when parallax does not greatly fluctuate temporarily, the user can check the parallax information as well as the image data representing the stereo image on the display unit 5.

The stereo camera 200 according to this embodiment can display parallax information on a pointed position at least as well as an image based on the image data representing the stereo image. Further, the parallax information on the pointed position can be easily adjusted. For this reason, this embodiment can provide the stereo camera 200 that is easy-to-use for users.

### 5. Another Embodiment

In the above embodiment, an image captured by the first optical system 210 and an image captured by the second optical system 220 are converted into digital signals by the AID converter 213 and the AID converter 223, respectively, thereafter the signal processes are executed for calculating parallax information and adjusting parallax information. However, for example, parallax information may be processed inside the imaging unit 1 and in a format of an analog signal.

Further, as the method for adjusting parallax information, the method for shifting a relative position between a right-eye image and a left-eye image to change parallax information, and a method for changing an optical axis angle of the optical system to change parallax information are used. However, any methods for enlarging or reducing an image can be used as long as parallax information is changed.

In the above embodiment, parallax information is changed by the user according to the dragging operation on the operation unit 6, but parallax information may be changed according to a pinch-in operation and a pinch-out operation for changing a gap between user's two fingers on the operation unit 6.

Further, the stereo camera according to the present disclosure may include a CPU (Central Processing Unit), a system LSI (Large Scale Integration), a RAM (Random Access Memory), a ROM (Read Only Memory), an HDD (Hard Disk Drive), and a network interface. Further, a drive device that can carry out reading from or writing into portable recording media such as a DVD-RAM, a Blu-ray disc and an SD (Secure Digital) memory card.

The stereo camera according to the present disclosure is incorporated into a digital video camera, a digital camera and a mobile telephone as a built-in system.

Respective functions of the stereo camera may be realized by installing programs for controlling the stereo camera (hereinafter, image capturing programs) into an HDD or a ROM and executing the image capturing programs.

The image capturing programs may be recorded in a recording medium readable by a hardware system such as a computer system and an embedded system. Further, the image capturing programs may be read by another hardware system via the recording medium to be executed. As a result, the respective functions of the stereo camera can be realized in another hardware system. Examples of the recording medium readable by the computer system are optical recording media (for example, CD-ROM), magnetic recording media (for example, hard disc), magneto-optical recording media (for example, MO), and semiconductor memories (for example, memory card).

Further, the image capturing programs may be saved in a hardware system connected to a network such as an Internet and a local area network. The programs may be downloaded into another hardware system via a network to be executed. As a result, the respective functions of the stereo camera can be realized in another hardware system. Examples of the network are a terrestrial broadcasting network, a satellite broadcasting network, a PLC (Power Line Communication), a mobile telephone network, a wire communication network (for example, IEEE802.3), and a wireless communication network (for example, IEEE802.11).

In another manner, the respective function of the stereo camera may be realized by an image capturing circuit built in the stereo camera.

The image capturing circuit may be formed by a full custom TSI (Large Scale Integration), a semi-custom LSI such as an ASIC (Application Specific Integrated Circuit), a programmable logic device such as an FPGA (Field Programmable Gate Array) or a CPLD (Complex Programmable Logic Device), or a dynamic reconfigurable device of which circuit configuration can be rewritten dynamically.

Design data for forming the respective functions of the stereo camera in an image capturing circuit may be configured by a program described by hardware description language (hereinafter, an HDL program). The design data may be configured by a net list of a gate level obtained by synthesizing logics of the HDL program. The design data may be configured by macro cell information obtained by adding arrangement information and process conditions to the net list of the gate level. The design data may be configured by mask data where a dimension, timing and the like are defined. Examples of the hardware description language are VHDL (Very high speed integrated circuit Hardware Description Language), and Verilog-HDL, and System C.

The design data may be recorded in a recording medium readable by a hardware system such as a computer system and an embedded system. The design data may be loaded into another hardware system via a recording medium to be executed. The design data read by another hardware system via the recording media may be downloaded into a programmable logic device via a download cable.

Further, the design data may be retained in a hardware system connected to a network such as an Internet or a local area network. The design data may be downloaded into another hardware system via a network to be executed. The design data obtained by another hardware system via the network may be downloaded into a programmable logic device via a download cable.

The design data may be recorded in a serial ROM to be transferred to FPGA at an electrically connected time. The design data recorded in the serial ROM may be downloaded directly into FPGA at the electrically connected time.

Further, the design data may be generated by a microprocessor at a time of electrical connection to be downloaded into FPGA.

Further, the technical idea disclosed in the above embodiment can be adapted to a television receiver which has a receiver instead of an imaging unit.

### INDUSTRIAL APPLICABILITY

The present disclosure can be used as the stereo camera for capturing a stereoscopic video signal, and particularly as a video camera recorder that is capable of easily adjusting parallax information using a touch panel at a time of capturing a stereoscopic video signal.

What is claimed is:

1. A stereo image display device, comprising:
an image input unit operable to obtain image data representing a stereo image;
a display unit operable to display an image based on the image data obtained by the image input unit;
a operation unit operable to receive pointing position on an image displayed on the display unit;
an information calculator operable to obtain parallax information on a portion corresponding to the position pointed by the operation unit in the image data obtained by the image input unit; and
a controller operable to control the display unit to display the parallax information obtained by the information calculator as well as the image, wherein
the display unit displays the parallax information in a format representing a magnitude and a direction of parallax,
the operation unit receives a command for changing the magnitude of parallax represented by the parallax information,
the controller changes a magnitude of parallax on the portion corresponding to the pointed position in the image data based on the changing command received by the operation unit.

2. The stereo image display device according to claim 1, wherein the controller controls the display unit to display the parallax information obtained by the information calculator near the position pointed by the operation unit.

3. The stereo image display device according to claim 2, wherein the controller controls the display unit to display the parallax information obtained by the information calculator in a format of vector.

4. The stereo image display device according to claim 1, further comprising:
an imaging unit operable to capture the stereo image, wherein
the image input unit obtains the image data representing the stereo image from the imaging unit,
the operation unit receives the command for changing the magnitude of parallax represented by the parallax information,
the controller controls a shooting parameter in the imaging unit, to change the magnitude of parallax based on the changing command.

5. The stereo image display device according to claim 3, further comprising:
a setter operable to set information about the magnitude of parallax of the image data representing the stereo image,
wherein the controller controls the display unit to display the parallax information in a different display format between a case where a size of parallax information obtained by the information calculator is larger than the magnitude of parallax set by the setter and a case where the size of parallax information obtained by the information calculator is smaller than the magnitude of parallax set by the setter.

6. The stereo image display device according to claim 1, wherein the display unit and the operation unit are formed integrally as a touch panel that can detect a user's touching operation while displaying at least the image based on the image data.

7. The stereo image display device according to claim 6, wherein when the touching operation on a portion at which the parallax information is displayed is detected continuously at a plural number of times while the parallax information is displayed, the operation unit receives the touching operation as the changing command.

8. The stereo image display device according to claim 6, wherein when a dragging operation on a display portion at which the parallax information is displayed is detected while the parallax information is displayed, the operation unit receives the dragging operation as the changing command.

9. The stereo image display device according to claim 1, wherein
the information calculator further obtains maximum parallax information about maximum parallax in parallax information of the image data,
when a position of a portion having the maximum parallax in image data is changed by changing the magnitude of parallax based on the changing command, the controller controls the display unit to display information representing that the position of the portion having the maximum parallax in the image data is changed.

10. The stereo image display device according to claim 1, wherein
the information calculator further obtains a predetermined number of pieces of parallax information about the image data in decreasing order starting from the parallax information having the largest magnitude of parallax, in parallax information of the image data,
the controller controls the display unit to display the parallax information on the portion corresponding to the pointed position and the predetermined number of pieces of parallax information.

11. The stereo image display device according to claim 1, wherein
the information calculator further obtains parallax information on a portion corresponding to a focus region on the stereo image in image data,
the controller controls the display unit to display the parallax information on the portion corresponding to the pointed position and the parallax information on the portion corresponding to the focus region.

12. The stereo image display device according to claim 1, further comprising:
a detector operable to detect a movement of the stereo image display device,
wherein when the detector detects the movement of the stereo image display device, the controller controls the display unit to display only the image data obtained by the image input unit.
